(19) United States
(12) Patent Application Publication
(10) Pub. No.: US 2007/0089797 A1
(43) Pub. Date: Apr. 26, 2007

(54) Preformed liner adhered to a pipe with an adhesive

(76) Inventor: Kimberly Dawn Farnsworth, Walker, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/586,286

(22) Filed: Oct. 25, 2006

Related U.S. Application Data
(60) Provisional application No. 60/730,535, filed on Oct. 26, 2005.

(51) Int. Cl. F16L 55/16

(52) U.S. Cl. 138/98; 138/97; 405/150.1; 156/287; 156/294; 264/36.17; 264/36.15; 264/269

(57) ABSTRACT

The present invention relates to a preformed liner adhered to the surface of a pipe, and in particular, an oil well pipe, by an adhesive. The liner comprises a polymer, preferably a fluoropolymer. The present invention also relates to a process for adhering the preformed liner to the interior surface of a pipe, and in particular by applying adhesive to the preformed liner. The liner is preferably treated prior to applying the adhesive. A suitable treatment includes etching. The pipe is heated to adhere the preformed liner to the interior surface of the pipe, without buckling the liner. The interior surface of the preformed fluoropolymer liner reduces the deposition of at least one of 1) asphaltenes, 2) paraffin wax, and 3) inorganic scale by at least 40% as compared to the interior surface of the oil pipe without the preformed liner being present.

### FIELD OF THE INVENTION

This invention relates to a preformed polymer liner adhered to a surface of a pipe (e.g. the interior and/or exterior surface), and in particular, an oil well pipe, by an adhesive. In particular a thermoset adhesive. The liner may comprise a fluoropolymer both melt processible and non-melt processible.

### BACKGROUND OF THE INVENTION

Pipes used in the production and transportation of chemicals are subject to corrosion and plugging. An example of such a pipe is oil pipe which is generally large and for reasons of economy is manufactured from carbon steel rather than more expensive corrosion resistant alloys. Corrosion is induced by the hot underground environment in which down-hole pipes convey oil from deeply buried deposits to the earth's surface. Materials such as water, sulfur, sulfur dioxide, carbon dioxide, present in the oil typically make it acidic causing corrosion of the interior surface of the pipe. Even at cooler temperatures, transportation pipelines that extend for long distances close to the earth's surface experience the effects of corrosion because of the long contact times involved. Corroded pipes are difficult and expensive to replace.

Methods of lining tubular members in general are known, see for example, U.S. Pat. No. 2,833,686 to Sandt and Research Disclosure No. 263060, which both describe liners made of polytetrafluoroethylene, which is a non-melt-processible fluoropolymer. In addition, a fluoropolymer preformed liner is disclosed in U.S. Pat. No. 3,462,825 to Pope. Both of these references use a fluorinated ethylene propylene bonding agent, which does not provide particularly good adherence because of the non-stick properties of fluoropolymers generally and require high application temperatures to achieve adherence.

A fluoropolymer preformed liner for a pipe is disclosed in U.S. Pat. No. 3,462,825 to Pope. However, pressure and temperature cycling that may occur in the use of such lined pipes may cause the lining to buckle, pulling away from the interior surface allowing accumulation of gases and liquids between the liner and the wall surface and narrowing the path of oil flow.

WO 2005/100843 discloses the use of a preformed liner of fluoropolymer adhered to a pipe's surface with the aid of a primer layer containing a fluoropolymer and a heat resistant polymer binder.

EP 0278 685 employs photocurable epoxy adhesives for bonding fluoropolymers to metal substrates.

What would be desirable is a pipe with an interior surface which resists the deposit of insoluble organic materials and inorganic materials and has resistance to the corrosive effects of acids. Further there is a desire that the interior surface be durable and adhere well to the pipe, and is not likely to buckle, when subjected to corrosive conditions for many years in harsh environments.

### BRIEF SUMMARY OF THE INVENTION

With the present invention, buckling is prevented because of the presence of an adhesive on the pipe's interior surface which uniformly bonds the liner to the interior surface. The preferred adhesive is a thermoset adhesive. It is unexpected that the preformed liner adheres to the adhesive. The bonding of the liner to the adhesive involves the heating of the pipe sufficiently to create a bond at the adhesive/liner interface and then cooling the pipe. The liner has a greater shrinkage during cooling than the pipe, which would tend to pull the liner away from the adhesive. Nevertheless, with the present invention, the adherence achieved in the heated condition remains intact, resulting in the liner that is adhered to the pipe by the adhesive layer. The preferred thermoset adhesives used in this invention promote uniform adhesion along the entire length of pipe thereby eliminating voids.

With the process of present invention, it is possible to adhere, to the interior surface of an oil well pipe, a preformed liner which is capable of reducing-to-eliminating the deposition (buildup) of one or more of the asphaltenes, paraffin wax, and inorganic scale on the interior surface of the oil pipe. Preferably, this reduction is at least 40%, preferably at least 50%, for at least one of these materials as compared to the unlined oil pipe, and more preferably at least 40% for all of them. These percent reductions can be determined by periodic measurements of the amount of build-up within the pipe or simply by observing the more than double the production time before the oil well must be shut down for cleaning. These deposition reductions are accompanied by the added benefit of corrosion protection as compared to unlined oil pipe. The reduced deposition performance of the lined pipes of the present invention is in contrast to the result obtained for oil pipes having an epoxy resin interior lining which is in contact with the oil.

Therefore, in accordance with the present invention, there is provided a pipe including a preformed liner adhered to the interior and/or exterior surface of the pipe by a thermoset adhesive wherein the preformed liner is a polymer.

Also in accordance with the present invention, there is provided an oil pipe comprising a preformed liner adhered to the interior surface of the oil pipe by a thermoset adhesive, preferably an epoxy adhesive, wherein the preformed liner is a polymer.

Further in accordance with the present invention, there is provided a process for adhering a preformed liner comprising a polymer, preferably a fluoropolymer, to the interior surface of a pipe, comprising applying an adhesive and heating the adhesive to adhere the preformed liner to the interior and/or exterior surface of the pipe. Heating occurs at a temperature that is at least 50° C. less than the melting point of the polymer.

In preferred embodiments of the invention, the preformed polymer liner has a thickness of about 20 mils to about 250 mils (i.e. i.e. 500-6350 micrometers), and preferably about 30 mils to about 200 mils (i.e. 750-5100 micrometers).

### DETAILED DESCRIPTION OF THE INVENTION

The present invention is directed to a pipe including a preformed liner adhered to the interior surface of the pipe by a thermoset adhesive, wherein the preformed liner is a polymer. While the discussion herein focuses on preformed liners inserted inside the pipe, it will also occur to those skilled in the art that in at least the melt-processible embodiment, the preformed liner can be inserted on the inside of the pipe, as a sleeve on the outside of the pipe, or both. The preformed liner would be useful in reducing the corrosive effects of the environment, even though the environments encountered inside and outside the pipe are different. A change in the location of the preformed liner from the inside to the outside of the pipe, or adding an additional preformed layer outside the pipe would simply be an additional embodiment of this disclosure and would not be a departure from the spirit of this invention.

In particular, the pipe may be an oil conveying pipe, or oil pipe. The oil pipe may be used as a succession of such pipes in an oil transportation pipeline or a down-hole oil well pipeline, it being understood, however, that the pipe of the present invention is not so limited. Oil pipes are generally large, having an inner diameter of at least 2 in (5 cm) and sometimes as large as 6 in (15.24 cm) and length of at least 10 ft (3 m), more often at least 20 ft (6.1 m) and often a length of at least 30 ft (9.1 m).

The pipes are typically made from rigid metal, although they could be made of flexible metal tubing. For reasons of economy, they are usually made of carbon steel and as such are prone to corrosive attack from acidic entities in the oil unless protected by a corrosion resistant coating. In this invention, a surface which is both corrosion resistant and which possesses good release characteristics is applied to the interior surface of the pipe. Beneficial effects are also seen for pipes that are made from other substrates such as aluminum, stainless steel and other corrosion resistant alloys.

In an especially preferred embodiment, the preformed liner typically has a thickness from about 20 mils to about 250 mils (i.e. 500-6350 micrometers), preferably about 30 mils to about 200 mils (i.e. 750-5100 micrometers), more preferably from about 20 mils to about 100 mil (i.e. 500-2550 micrometers, and even more preferably 30 to 100 mils(i.e. 750 to 2550 micrometers). With liners of this thickness, 30 mils or greater, thermoset adhesives are advantageous. Heat is needed to cure a thermoset adhesive and the presence of heat helps to expand the liner forcing it against the wall of the pipe. If heat were not used, such as with photocurable adhesives, the liner, especially thick liners as used in preferred embodiments of this invention, will not be encouraged to expand and adhere uniformly against the pipe wall. Thus, buckling may occur while the pipe is in use. Gaps or voids formed when the liner buckles allow for accumulation of gases and liquids between the liner and the wall surface which over time leads to pipe corrosion. Such heat is especially useful with the non-melt processible fluoropolymer which is one of the embodiments of this invention, as will be discussed below.

Adhesives, preferably thermoset adhesives, are preferably selected with curing temperatures which are at least 50° C. less than the melting point of the polymer in the preformed line, preferably less than 75° C., and more preferable less than 100° C. Adhesives that cure at these low temperatures are chosen in order to avoid melting the polymer and thereby reducing the forces associated with shrinkage upon cooling the liner from a molten or semi-molten polymer state. A key to obtaining durable uniform adherence of the polymer lining is optimizing the application of heat and selecting adhesives which work in the optimal temperature range.

By “thermoset adhesive”, it is meant polymer adhesives that are formed only once upon the application of heat and or pressure. Polymers that can be formed repeatedly by application of heat and pressure are called “thermoplastics”. (Principles of Polymer Systems by Ferdinand Rodriguez Taylor & Francis, Philadelphia, Pa. Copyright 1996) The advantage of thermoset materials over thermoplastic materials in an embodiment of this invention is that once heated, they react irreversibly so that the subsequent applications of heat and pressure will not cause them to soften and flow. In contrast, thermoplastic polymers soften without chemical change when heated, and harden when cooled and therefore may be subject to changing heat and pressure conditions, especially in the harsh environments of downhole oil pipes.

The adhesive needs only to be thick enough to adhere the preformed liner to the interior surface of the oil pipe. The vastness of the interior surface of this pipe over which the preformed liner is unsupported except by adhesion to the interior surface of the pipe requires high integrity for the adhesion. Otherwise the varying conditions of temperature, pressure and even mechanical contacts can cause the liner to separate from the interior surface, leading to loss in corrosion and possibly even non-stick protection if the liner ruptures. Further, separation of the liner may result in collapse of the liner causing reduced flow or even plugging.

Therefore, according to the present invention, an adhesive may be used to provide the adhesion of the preformed liner to the interior surface of the pipe. The term adhesion or adhered means that the liner passes the 90° Peel Test, as will be described below in the Examples. The peel strength which can be achieved by the present invention is at least 10 pounds force per inch (10 lbf/in), preferably at least twenty pounds force per inch (20 lbf/in), and more preferably thirty pounds force per inch (30 lbf/in).

The adhesive may be selected from a variety of materials which are applied with the use of heat. The adhesive is preferably a thermoset adhesive, more preferably a thermoset epoxy. Epoxies, which contain no volatile solvents, are particularly well-suited for use with the present invention, because no volatiles will be released/trapped between the pipe wall and the liner. As explained above, the thermoset epoxy used in this invention is cured at a temperature which is at least 50° C. less than the melting point of the polymer in the preformed liner, preferably at least 75° C., and more preferably at least 100° C.

Also, epoxies which are thermosets that cure at relatively low temperatures are desirable to use. Epoxy cure temperatures are generally less than 500° F. (260° C.) and may be much lower. Thus, in general epoxies are processed at a lower temperature than fluoropolymer primers or fluoropolymer bonding agents of the prior art so that the maximum temperatures needed with the adhesive embodiment are lower than those needed with these prior art compositions. This translates to reduced shrinkage forces upon cool down.

Commercially available epoxies which may be used with the present invention include ECCOBOND® A 359. This epoxy is a one part thermoset epoxy marketed by Bondmaster. Cure cycle ranges from 90 min at 100° C. to 40 seconds at 200° C. This epoxy is filled with aluminum and has a consistency of a thick paste. Service temperature range is 40 to 356° F. (−40 to +180° C.). In another embodiment, a two-part adhesive system, such as Duralco 4539N resin, is suitable for use with the present invention. Duralco™ 4538N is a two part epoxy marketed by Cotronics Corporation (Brooklyn, N.Y.) as a “rubber like” flexible epoxy. Its cure cycle ranges from 24 hrs at room temp to a few minutes at elevated temperature. Its consistency is that of warm table syrup, and its upper service temperature is 450° F. (232° C.).

Other adhesives suitable for use with the present invention include those adhesives that can be applied at a temperature which is at least 50° C. less than the melting point of the polymer in the preformed liner, preferably at least 75° C., and more preferably at least 100° C. Examples of adhesives include, but are not limited to, silicones, polyamides, polyurethanes, and acrylic based systems.

In certain embodiments of the present invention, including the oil well pipe embodiment, the preformed liner may comprise a fluoropolymer. The fluoropolymer is selected from the group of polymers and copolymers of trifluoroethylene, hexafluoropropylene, monochlorotrifluoroethylene, dichlorodifluoroethylene, tetrafluoroethylene, perfluorobutyl ethylene, perfluoro(alkyl vinyl ether), vinylidene fluoride, and vinyl fluoride and blends thereof and blends of the polymers with a nonfluoropolymer.

In one embodiment, the fluoropolymers used in this invention are melt-processible. By melt-processible it is meant that the polymer can be processed in the molten state (i.e., fabricated from the melt into shaped articles such as films, fibers, and tubes etc. that exhibit sufficient strength and toughness to be useful their intended purpose). Examples of such melt-processible fluoropolymers include copolymers of tetrafluoroethylene (TFE) and at least one fluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Such fluoropolymers include polychlorotrifluoroethylene, copolymers of tetrafluoroethylene (TFE) or chlorotrifluoroethylene (CTFE). Preferred comonomers of TFE are perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms).

The melt-processible copolymer is made by incorporating an amount of comonomer into the copolymer in order to provide a copolymer which typically has a melt flow rate of about 1-100 g/10 min as measured according to ASTM D-1238 at the temperature which is standard for the specific copolymer. Typically, the melt viscosity will range from 10 Pa·s to about 10 Pa·s, preferably 10 to about 10 Pa·s measured at 372° C. by the method of ASTM D-1238 modified as described in U.S. Pat. No. 4,380,618. Additional melt-processible fluoropolymers are the copolymers of ethylene or propylene with TFE or CTFE, notably ETFE, ECTFE ,PCTFE, TFE/ETFE/HFP (also known as THV) and TFE/E/HFP (also known as EFEP). Further useful polymers are film forming polymers of polyvinylidene fluoride(PVDF) and copolymers of vinylidene fluoride as well as polyvinyl fluoride (PVF) and copolymers of vinyl fluoride.

In another embodiment the fluoropolymer component is polytetrafluoroethylene (PTFE) including modified PTFE which is not melt-processible may be used together with melt-processible fluoropolymer or in place of such fluoropolymer. By modified PTFE is meant PTFE containing a small amount of comonomer modifier which improves film forming capability during baking (fusing), such as perfluoroolefin, notably hexafluoropropylene (HFP) or perfluoro(alkyl vinyl) ether (PAVE), where the alkyl group contains 1 to 5 carbon atoms, with perfluoro(ethyl vinyl) ether (PEVE) and perfluoro(propyl vinyl) ether (PPVE) being preferred. The amount of such modifier will be insufficient to confer melt fabricability to the PTFE, generally no more than 0.5 mole %. The PTFE, also for simplicity, can have a single melt viscosity, usually at least 1×10⁹ Pa·s, but a mixture of PTFE's having different melt viscosities can be used to form the fluoropolymer component. Such high melt viscosity indicates that the PTFE does not flow in the molten state and therefore is not melt-processible. It should be noted that when PTFE is used as the preformed liner, either an adhesive or a primer layer should preferably be used.

The melting temperature of the lining will vary according to its composition. By melting temperature is meant the peak absorbance obtained in DSC analysis of the lining. By way of example, tetrafluoroethylene/perfluoro(propyl vinyl ether) copolymer (TFE/PPVE copolymer) melts at 305° C., while tetrafluoroethylene/hexafluoropropylene melts at 260° C. (TFE/HFP copolymer). Tetrafluoroethylene/perfluoro—(methyl vinyl ether)/perfluoro(propyl vinyl ether) copolymer (TFE/PMVE/PPVE copolymer) has a melting temperature in between these melting temperature.

In a preferred embodiment the fluoropolymer in the preformed film of this invention is preferably selected from polyvinyl fluoride (PVF), fluorinated ethylene/propylene copolymer, ethylene/tetrafluoroethylene copolymer, tetrafluoroethylene/perfluoro(alkyl vinyl ether) copolymer, polyvinylidene fluoride and a blend of polyvinylidene fluoride and an acrylic polymer, preferably nonfluoropolymer acrylic polymer. In an especially preferred embodiment, the preformed liner consists essentially of, i.e., is a pure perfluoropolymer. The perfluoropolymer in the preformed liner is selected from the group consisting of copolymer of tetrafluoroethylene with perfluoroolefin, the perfluoroolefin containing at least 3 carbon atoms, and copolymer of tetrafluoroethylene with at least one perfluoro(alkyl vinyl ether), the alkyl containing from 1 to 8 carbon atoms.

The melting temperature of the lining will vary according to its composition. By melting temperature is meant the peak absorbance obtained in DSC analysis of the lining. By way of example, tetrafluoroethylenel perfluoro(propyl vinyl ether) copolymer (TFE/PPVE copolymer) melts at 305° C., while tetrafluoroethylene/hexafluoropropylene melts at 260° C. (TFE/HFP copolymer). Tetrafluoroethylene/perfluoro—(methyl vinyl ether)/perfluoro(propyl vinyl ether) copolymer (TFE/PMVE/PPVE copolymer) has a melting temperature in between these melting temperature.

When a melt-processible fluoropolymer is used for the preformed liner, the preformed liner can be made by well-known melt extrusion processes forming, as examples, preferred liners of ETFE, FEP and PFA. Further the preformed liner can be made from fluid compositions that are either solutions or dispersions of fluoropolymer by casting or by plasticized melt extrusion processes. Examples include blends of polyvinylidene fluoride, or copolymers and terpolymers thereof, and acrylic resin as the principal components. PVF is a semicrystalline polymer that can be formed into a preformed liner by plasticized melt extrusion. Despite the fact that there are no commercial solvents for PVF at temperatures below 100° C., latent solvents such as propylene carbonate, N-methyl pyrrolidone, γ-butyrolactone, sulfolane, and dimethyl acetamide are used to solvate the polymer at elevated temperatures causing the particles to coalesce and permit extrusion of a film containing latent solvent that can be removed by drying.

When a non- melt-processible fluoropolymer is used for the preformed liner, the liner can be made, for example, by methods including paste extrusion as described in U.S. Pat. No. 2,685,707. In paste extrusion, a paste extrusion composition is formed by mixing PTFE fine powder with an organic lubricant which has a viscosity of at least 0.45 centipoise at 25° C. and is liquid under the conditions of subsequent extrusion. The PTFE soaks up the lubricant, resulting in a dry, pressure coalescing paste extrusion composition that is also referred to as lubricated PTFE fine powder. During paste extrusion which is typically performed at a temperature of 20 to 60° C., the lubricated fine powder is forced through a die to form a lubricated green extrudate. The lubricated green extrudate is then heated, usually at a temperature of 100 to 250° C., to make volatile and drive off the lubricant from the extrudate. In most cases, the dried extrudate is heated to a temperature close to or above the melting point of the PTFE, typically between 327 ° C. and 500 ° C., to sinter the PTFE.

Alternatively, granular PTFE can be isostatically molded or ram extruded into a tubular liner and fitted into a pipe housing to form the preformed liner. In this embodiment, the liner is processed to a size somewhat larger than the inner diameter (I.D.) of the steel housing into which it is being installed. The thickness is typically 50-120 mil. The liner is preferably pulled through a reduction die into a pipe that has either an adhesive applied thereto. A programmed heating cycle relaxes the liner inside the steel housing, resulting in a snug liner fit.

In accordance with the present invention, there is provided a process for adhering a preformed liner comprising polymer, preferably a fluoropolymer, to the interior surface of a pipe, comprising applying an adhesive and heating the adhesive to adhere the preformed liner to the interior and/or exterior surface of the pipe. Heating occurs at a temperature that is at least 50° C. less than the melting point of the polymer, preferably at least 75° C. less than the melting point of the polymer, more preferably at least 100° C. less than the melting point of the polymer.

A pipe is made according to the process of the present invention in the following manner. Typically, the as-manufactured and supplied pipe, such as an oil pipe, will have a coating of preservative (rust inhibitor) on the interior, relatively smooth surface to resistance rust. The pipe interior surface may be cleaned and then roughened, for instance by grit blasting, thereby ridding such surface of contaminants that could interfere with adhesion and providing a more adherent surface for the primer layer if used and for the preformed film. Conventional soaps and cleansers can be used. The pipe can be first cleaned by baking at high temperatures in air, temperatures of 800° F. (427° C.) or greater. The cleaned interior surface is then preferably grit blasted, with abrasive particles, such as sand or aluminum oxide, or can be roughened, such as by chemical etching, to form a roughened surface to improve the adhesion of the adhesive. The grit blasting is sufficient to remove any rust that may be present, thereby supplementing the cleaning of the interior surface. The roughening that is desired for adhesive adhesion can be characterized as a roughness average of 1-75 micrometers.

The surface of the preformed liner may be treated before the adhesive is applied to the surface of the liner, or if the adhesive is applied to the interior or exterior surface of the pipe, before the liner is inserted into the pipe. This treatment may include etching, which encompasses chemical or mechanical etching. Chemical etching in particular strips some of the fluorines off the surface leaving a surface which can be wet by epoxy, other adhesives, etc. Etching may be accomplished using a sodium ammonia etch. Other surface treatments for improving the adhesion of the preformed liner include flame treatment, corona discharge treatment and plasma treatment, all of which are described in Schiers, “Modern Fluoropolymers”, Wiley Series in Polymer Science, 1997. It should be noted that there are also other commercial means to treat or etch fluoropolymers, and the present invention is not limited to those means discussed herein.

In a “slip fit” embodiment, the preformed liner is tubular, with the outer diameter of the tube being slightly smaller than the inner diameter of the pipe to be lined. This allows the liner to be freely slipped into the pipe. Upon heating, the liner will expand and adhere firmly to the inside of the pipe.

In certain other embodiments, the preformed liner is tubular, with the outer diameter of the tube being greater than the interior diameter of the pipe to be lined. In a preferred embodiment the initial outer diameter of the preformed liner is about 10 to 15% greater than the inner diameter of the pipe. In a more preferred embodiment, the preformed liner is applied to the interior surface of the pipe according to the teachings of U.S. Pat. No. 3,462,825 (Pope et al.) by gripping one end of the liner, pulling the liner into the oil pipe mechanically reducing the outer diameter, releasing the liner and allowing the liner to expand into tight engagement with the adhesive of the interior surface of the pipe. A preferred method for reducing the outer diameter is to pull the liner into the oil pipe through a reduction die as taught in Pope et al. Alternative means of reducing the diameter of the tubular liner such that it could be pulled into the oil pipe of smaller inner diameter include 1) pulling the tubular liner under tension such that the length of the liner increases and the diameter of the liner decreases as described in U.S. Pat. No. 5,454,419 to Vloedman or 2) pulling the tubular liner through diameter reducing rollers similar to those described in Canadian Patent 1241262 (Whyman et al). In either case, once the tubular liner is inserted in the oil pipe, it is released allowing the liner to expand into tight engagement with the adhesive of the interior surface of the pipe.

An alternate method of producing a lined pipe is called swaging. In this embodiment, the preformed film is preferably in the shape of tubular liner with the outer diameter of the tube being less than the interior diameter of the pipe to be lined. In a preferred embodiment, the initial outer diameter of the tubular liner is about 10 to 15% less than the inner diameter of the pipe. Swaging involves mechanically reducing the diameter of a steel pipe around a liner by use of a swaging device such as an Abby Etna Rotary Swager which applies an abundant amount of force to the pipe through hammering, for example, applying 2400 blows per minute to cause the pipe to fit around the liner.

Adhesive is applied to either the outside of the liner or the inside of the pipe prior to inserting the liner in the pipe. After the liner is inserted and the pipe is “swaged” down around the liner, the pipe is heated.

Depending upon the specifics of the liner (wall thickness, % reduction, and exact material composition) a heat cycle may be required to relax/re-expand the liner tightly against the pipe walls. For instance, PTFE may not re-expand as fully without addition of heat

After the liner is inserted in the pipe, the pipe is then heated to heat the adhesive in order to adhere the lining to the interior surface of the pipe. The pipe is heated by either oven heating or induction heating, or other heating mechanisms. For example, exposure to any heat source that is sufficient to activate the adhesive without melting the remainder of the liner would be suitable. These heat sources could also include but are not limited to, for example, flame treating and high temperature electrical resistance furnaces. Still other heat sources which can be used include the heat from a gas fired indirect heater. A very short duration heat source would also accomplish the objective. Detailed examples of such intense heat sources would include but are not limited to oxyacetylene torches and heating elements of molybdenum disilicide (available as Kanthal Super 33 heating elements from Kanthal Corporation, Bethel, Conn.).

In such an arrangement, very accurate temperature control could be achieved. This is because modest changes to the oven temperature would result in small temperature differences at the liner surface. The required oven temperature would then be determined empirically by adjusting the speed with which the pipe moves through the heated zone and the temperature of the zone.

This technique has been successfully applied to production of monofilaments (see, e.g. U.S. Pat. No. 4,921,668, Anderson, et. al. to DuPont) and U.S. Pat. No. 5,082,610, Fish, et. al. to DuPont) but has not been applied to lining pipes until now. These and other such changes in heating mechanism may all be made without departing from the spirit of this invention.

When induction heating is used, heat is essentially applied from the outside of the lined pipe inward. Induction heating of a metallic component is achieved by passing high-frequency electric current through a coil surrounding a workpiece. This in turn induces a high-frequency electromagnetic field in the piece. The magnetic field induces currents in the workpieces and the electrical resistance of the piece to the flow of current causes the piece to heat up.

The heat applied to the pipe is sufficient to cause the liner to expand against the interior surface of the pipe and adhere the liner to the surface of the pipe. Heating may be sufficient to cure a thermoset adhesive or melt a thermoplastic adhesive. The heat applied is at least 50° C. less than the melting point of the polymer, preferably at least 75° C. less than the melting point of the polymer and most preferably at least 100° C. less than the melting point of the polymer.

The maximum pipe temperature varies according to the particular adhesive being used, and may go up to to 700° F., with the lower end of this temperature range being 200° F. (93° C.) Time for adherence will be dependent on the heating temperature used, but the time of exposure to the maximum temperature is typically in the range of 5 minutes to 60 minutes. When induction heating is used, the time of exposure to the maximum temperature is typically in the range of seconds.

In the induction heating process of the present invention, the pipe moves in proximity to the heating induction coil at a scanning rate of 1-30 inches per minute, preferably 10-20 inches per minute. Alternatively, the heating induction coil may be moved in proximity to the pipe at these scanning rates.

According to the process of the present invention, after the heating step, the pipe is then cooled. The cooling rate may be controlled in different ways. Options for cooling include 1) room temperature air cooling or 2 via cooling rings, water jets, etc.

With the present invention, the pipes can be moved along the heating induction coil, or vice versa, so that one can process large pipes without the need for a bulky, standard convection oven, which is requires a large capital investment. Moreover, the process of the present invention allows the liner to be adhered in the field, allowing for on-site construction or repair, which significantly increases the flexibility of applying a liner.

In typical applications, the expansion of the preformed liner during the heating step, while theoretically greater than the expansion of the pipe, is limited by the relaxation effect of the heating of the liner to the molten or near molten condition. As the pipe cools, there is a tendency for the preformed liner to shrink. The shrinkage of the liner during cooling starts from this relaxed condition and then outpaces the shrinkage of the pipe. By the process of this invention, where the heat applied is at least 50° C. less than the melting point of the polymer, shrinkage forces are reduced. Unexpectedly, the interlayer adhesion between the adhesive and the preformed liner is sufficient to prevent the liner from pulling away from the adhesive. In the present invention, the expansion fit of the prior art for lining a pipe is improved by a liner with uniform adherence that resists separation and buckling characteristic of unadhered liners.

In prior art systems where adherence of a liner is poor, gas is able to permeate through the liner to both corrode the pipe and to exert pressure on the liner from the metal interface side of the liner. This results in blistering at the metal interface and eventual buckling of the liner to constrict and possibly block the interior of the pipe. Pipes of the present invention are able to deter the permeation of gases and vapors and resist the accumulation of chemicals at the interface of the pipe and adhesive/liner greatly retarding catastrophic failure. Moreover, the preformed liner of the pipes of the present invention is sufficiently thick and defect free so as to minimize the passage of corrosive material to the interior surface of the pipe.

Therefore, for all of the foregoing reasons, pipes of the present invention are able to withstand the harsh conditions of oil production. These pipes are able to withstand typical reservoir conditions that are at least about 250° F. (121° C.) and 7,500 psi (52 MPa), with 275° F. (135° C.) and 10,000 psi (69 MPa) being quite common. The pipes of the present invention are also able to withstand conditions as high as 350° F. (177° C.) and 20,000 psi (138 MPa) present in some high temperature/high pressure reserves. The invention is also applicable to pipe used in the Chemical Processing Industry (CPI), especially in those applications where temperatures such as those described above are encountered. In the CPI temperatures of at least about 350° F. (177° C.) and even as high as 400° F. (204° C.) are used. The pipes of the preferred embodiment of this invention show superior permeation resistance to corrosive chemicals due to both to their construction, i.e., adhesive and thick preformed film, and their strong adherence to the interior surface of the pipe. The lined pipes of the present invention are able to withstand the above described conditions for continuous service, e.g., for at least 30 days, preferably at least 60 days, and more preferably at least 12 months.

The preformed liner is impermeable to the corrosive materials present in the oil and presents a nonstick surface to the oil, whereby the insoluble organic materials present in the oil do not stick to the liner and restriction of oil flow and plugging is avoided. Further the preformed liner of the present invention is able to provide insulation to the oil pipe to mitigate the change from hot underground conditions to cooler earth surface effects, thereby resisting the deposit of the insoluble organic and inorganic materials. Preformed liner comprising fluoropolymer of the present invention possess good abrasion resistance to sand and rock contained in the oil and resist effects of tools scraping on the interior surface of pipe as these instruments are being lowered into the well for various measuring or servicing operations. The preformed liners of this invention resist both penetration and wear.

Because of all the above-noted advantages, the present invention is capable of reducing the deposition of at least one of asphaltenes, paraffin wax and inorganic scale by at least 40%, preferably at least 50%, as compared to the interior surface of the oil pipe without the lining being present. These reductions are also made in comparison to pipe lined with only an epoxy resin on the interior surface of the pipe. In fact, reductions of at least 60%, 70%, 80% and even at least 90% have been realized. Preferably these reductions apply to at least two of the deposition materials, and more preferably, to all three of them. Thus, in accordance with the present invention, there is also provided a method for reducing the deposition in a rigid oil well pipe of at least one of asphaltenes, paraffin wax, and inorganic scale by at least 40% as compared to the interior surface of the oil pipe without the liner being present. In addition, the preformed liner provides corrosion protection to the interior surface of the pipe.

### EXAMPLES

### Sample Preparation and Test Method

Adhesion Testing

Adhesion testing is performed using a modified version of ASTM D 6862-04 “Standard Test Method for 90 Degree Peel Test of Adhesives”. The test apparatus is the same as described in the ASTM. This apparatus allows for a 90° angle to be maintained between the preformed liner and the substrate (the carbon steel pipe) during the entire test. The test specimens are ⅜″-½″ wide strips cut vertically from the sample pipes. The test specimens are each ˜12 in long. Peel strength (lbf/in) is measured over at least 3 inches, (disregarding at least the first 1 inch of the peel as suggested in ASTM D 6862-04) and is reported as an average value. The superior adhesion of the substrate pipes with nonstick liners in the Examples of this invention is evident when a comparison is made to substrate pipes prepared in the Comparative Examples. That comparison is summarized in Table 3. As noted above, the peel strength which can be achieved by the present invention is at least ten pounds force per inch (10 lbf/in), and preferably at least twenty pounds force per inch (20 lbf/in), and more preferably greater than thirty pounds force per inch (30 lbf/in).

The adhesive layers formed in the following Examples are comprised of a commercially available epoxy resins and known as ECCOBOND® A-359 and Duralco™ 4538N and have the following composition:

TABLE 1
Adhesive Layer

| | Adhesive Layer | |
|---|---|---|
| Ingredient | ECCOBOND ® A 359 | Duralco ™ 4538N |
| Wt % DGEBA | 30-60 | |
| Epoxy Resin | | |
| Wt % Aluminum | 10-30 | |
| Wt % Mineral | 1-10 | |
| Filler, Curing | | |
| Agent, Modifier | | |
| Wt % Proprietary | | 100 |
| Modified Epoxy | | |
| Resin | | |

DGEBA: Diglycidyl ether of bisphenol A

The pre-formed polymer liners in the Examples have the following compositions:

TABLE 2
Preformed Liner Layer

Preformed Liner

| Composition | PFA | PTFE |
|---|---|---|
| Wt % TFE | 95.8 | 100 |
| Wt % PPVE | 4.2 | |

In the following Examples, the substrates for adhering a preformed liner are carbon steel pipes with a 3 inch inner diameter (ID). The inside of the pipes is grit blasted with 40 grit aluminum oxide to a roughness of approximately 70-125 microinches (1.8-3.2 micrometers) Ra. The preformed liners may be fabricated via melt extrusion, in the case of melt-processible fluoropolymers, or in the case of non-melt-processible fluoropolymers by other standard processing techniques including ram extrusion, paste extrusion, or isostatic molding. The particular technique used for fabricating the liner does not effect the adherence results.

The preformed liners are applied to the interior surface of the pipe via a “slip-fit”. In a “slip-fit”, the liner is manufactured to have an outer diameter (OD) slightly smaller than the inner diameter (ID) of the pipe such that it can be freely slid into the pipe without the use of mechanical diameter reduction equipment. On a commercial scale, pipes could be lined using the more standard interference lining technique taught in U.S. Pat. No. 3,462,825 (Pope et al.) and they could be coated with an adhesive while under tension.

### Comparative Example A

### PFA on Bare Steel

A preformed PFA liner of ˜1300 micrometers (50 mil) thickness is inserted into grit-blasted pipe via “slip-fit”. The lined pipe is placed in a standard convection oven which has been preheated to 302° F. (150° C.). Once the sample reaches the target temperature of 302° F., the sample remains in the oven for 60 minutes. After removing the sample from the oven and allowing it to cool, the liner slides freely out of the pipe indicating no adhesion between the liner and the pipe.

### Example 1

### PFA with Duralco™ 4538N Epoxy

A preformed PFA liner of ˜1300 micrometers (50 mil) thickness is chemically etched using a solution of sodium in liquid ammonia. The outside of the liner is then “painted” with a coat of Duralco™ 4538N adhesive. The liner, now coated with epoxy, is slid into a grit-blasted pipe and has a snug “slip-fit”. The lined pipe is placed in a standard convection oven which has been preheated to 302° F. (150° C.). Once the sample reaches the target temperature of 302° F., the sample remains in the oven for 60 minutes. After removing the sample from the oven and allowing it to cool, the sample is cut into strips and adhesion strength of the liner to the pipe wall is 20 lbf/in.

### Comparative Example B

### PFA on Bare Steel

A preformed PFA liner of ˜1300 micrometers (50 mil) thickness is inserted into grit-blasted pipe via a “slip-fit”. The lined pipe is placed in a standard convection oven which has been preheated to 392° F. (200° C.). Once the sample reaches the target temperature of 392° F., the sample remains in the oven for 15 minutes. After removing the sample from the oven and allowing it to cool, the liner slides freely out of the pipe indicating no adhesion between the liner and the pipe.

### Example 2

### PFA with ECCOBOND® A 359 Epoxy

A preformed PFA liner of ˜1300 micrometers (50 mil) thickness is chemically etched using a solution of sodium in liquid ammonia. The outside of the liner is then “painted” with a coat of ECCOBOND® A 359 adhesive. The liner, now coated with epoxy, is slid into a grit-blasted pipe and has a snug “slip-fit. The lined pipe is placed in a standard convection oven which has been preheated to 392° F. (200° C.). Once the sample reaches the target temperature of 392° F., the sample remains in the oven for 15 minutes. After removing the sample from the oven and allowing it to cool, the sample is cut into strips and the adhesion strength of the liner to the pipe wall is 40 lbf/in.

### Comparative Example C

### PTFE

A preformed PTFE liner of ˜3900 micrometers (150 mil) thickness is slid into a grit-blasted pipe and has a snug “slip-fit”. The lined pipe is placed in a standard convection oven which has been preheated to 302° F. (150° C.). Once the sample reaches the target temperature of 302° F., the sample remains in the oven for 60 minutes. After removing the sample from the oven and allowing it to cool, the liner slides freely out of the pipe indicating no adhesion between the liner and the pipe.

### Example 3

### PTFE with Duralco™ 4538N

A preformed PTFE liner of ˜3900 micrometers (150 mil) thickness is chemically etched using a solution of sodium in liquid ammonia. The outside of the liner is then “painted” with a coat of Duralco™ 4538N adhesive. The liner, now coated with epoxy, is slid into a grit-blasted pipe and has a snug “slip-fit”. The lined pipe is placed in a standard convection oven which has been preheated to 302° F. (150° C.). Once the sample reaches the target temperature of 302° F., the sample remains in the oven for 60 minutes. After removing the sample from the oven and allowing it to cool, the sample is cut into strips and adhesion strength of the liner to the pipe wall is 30 lbf/in.

### Comparative Example D

### PTFE

A preformed PTFE liner of ˜3900 micrometers (150 mil) thickness is slid into a grit-blasted pipe and has a snug “slip-fit”. The lined pipe is placed in a standard convection oven which has been preheated to 392° F. (200° C.). Once the sample reaches the target temperature of 392° F., the sample remains in the oven for 60 minutes. After removing the sample from the oven and allowing it to cool, the liner slides freely out of the pipe indicating no adhesion between the liner and the pipe.

### Example 4

### PTFE with ECCOBOND® A 359 Epoxy

A preformed PTFE liner of ˜3900 micrometers (150 mil) thickness is chemically etched using a solution of sodium in liquid ammonia. The outside of the liner is then “painted” with a coat of ECCOBOND® A 359 epoxy. The liner, now coated with epoxy, is slid into a grit-blasted pipe and has a snug “slip-fit”. The lined pipe is placed in a standard convection oven which has been preheated to 392° F. (200° C.). Once the sample reaches the target temperature of 392° F., the sample remains in the oven for 15 minutes. After removing the sample from the oven and allowing it to cool, the sample is cut into strips and adhesion strength of the liner to the pipe wall is 50 lbf/in.

### Example 5

### PTFE with ECCOBOND® A 359 Epoxy

A preformed PTFE liner of ˜3900 micrometers (150 mil) thickness is chemically etched using a solution of sodium in liquid ammonia. The outside of the liner is then “painted” with a coat of ECCOBOND® A 359 epoxy. The liner, now coated with epoxy, is slid into a grit-blasted pipe and has a snug “slip-fit”. The lined pipe is induction heated to 420° F. (216° C.). Induction heating conditions include: frequency=23 kHz, power level=15 kW, and scan rate=20 in/min. After the sample cools, it is cut into strips and adhesion strength of the liner to the pipe wall is 50 lbf/in.

TABLE 3
Peel/Adhesion Strength

| | | | | Adhesive |
|---|---|---|---|---|
| Example | Liner | Adhesive | Heating Technique | Strength |
| Comp A | PFA | None | Convection Oven - 302° F. | 0 lbf/in |
| 1 | Etched | Duralco ™ 4538N | Convection Oven - 302° F. | 20 lbf/in |
| | PFA | | | |
| Comp B | PFA | None | Convection Oven - 392° F. | 0 lbf/in |
| 2 | Etched | ECCOBOND ® A 359 | Convection Oven - 392° F. | 40 lbf/in |
| | PFA | | | |
| Comp C | PTFE | None | Convection Oven - 302° F. | 0 lbf/in |
| 3 | Etched | Duralco ™ 4538N | Convection Oven - 302° F. | 30 lbf/in |
| | PTFE | | | |
| Comp D | PTFE | None | Convection Oven - 392° F. | 0 lbf/in |
| 4 | Etched | ECCOBOND ® A 359 | Convection Oven - 392° F. | 50 lbf/in |
| | PTFE | | | |
| 5 | Etched | ECCOBOND ® A 359 | Induction Heating - 420° F. | 50 lbf/in |
| | PTFE | | | |

What is claimed is:

1. A pipe comprising a preformed liner adhered to a surface of a pipe by a thermoset adhesive, wherein the preformed liner is a polymer

2. An oil pipe comprising a preformed liner adhered to an interior surface of said oil pipe by a thermoset adhesive, wherein the preformed liner is a polymer.

3. The pipe of claim 1, wherein said polymer is a fluoropolymer.

4. The pipe of claim 1, wherein the thermoset adhesive is cured at a temperature of at least 50° C. less than the melting point of said polymer.

5. The pipe of claim 1, wherein the thermoset adhesive is cured at a temperature of at least 75° C. less than the melting point of the polymer.

6. The pipe of claim 1, wherein the preformed liner has a thickness of about 20 mils (500 micrometers) to about 250 mils (6350 micrometers).

7. The pipe of claim 1, wherein the preformed liner has a thickness of about 30 mils (750 micrometers) to about 200 mils (5100 micrometers).

8. The pipe of claim 1, wherein the preformed liner comprises being adhered to an interior surface of the pipe, an exterior surface of the pipe, or both the interior and exterior surface of the pipe.

9. The pipe of claim 1, wherein said thermoset adhesive is an epoxy.

10. The pipe of claim 3, wherein the fluoropolymer is melt-processible.

11. The pipe of claim 10, wherein the melt-processible fluoropolymer is selected from the group consisting of polychlorotrifluoroethylene, copolymers of tetrafluoroethylene (TFE) and chlorotrifluoroethylene (CTFE).

12. The pipe of claim 10, wherein the melt-processible fluoropolymer is a copolymer of TFE, wherein a comonomer is selected from the group consisting of a perfluoroolefin having 3 to 8 carbon atoms and a perfluoro(alkyl vinyl ether) (PAVE) having a linear or branched alkyl group containing 1 to 5 carbon atoms.

13. The pipe of claim 3, wherein the polymer is a non-melt-processible fluoropolymer.

14. The pipe of claim 13, wherein the non-melt-processible fluoropolymer is polytetrafluoroethylene (PTFE) or modified PTFE.

15. The pipe of claim 1, wherein said preformed liner has a treated surface to which said thermoset adhesive is applied.

16. The pipe of claim 1, wherein said preformed liner adheres to the surface of the pipe by said thermoset adhesive having a peel strength of at least 10 pounds force per inch (10 lbf/in).

17. The pipe of claim 1 wherein said preformed liner adheres to the surface of the pipe by said thermoset adhesive having a peel strength of at least twenty pounds force per inch (20 lbf/in).

18. A process for adhering a preformed liner to an interior surface of a pipe, comprising: a) applying an adhesive to a surface; and b) heating the adhesive to adhere the preformed liner to the interior surface of the pipe wherein the heating applied is at least 50° C. less than the melting point of the polymer.

19. The process of claim 18, wherein the heating applied is at least 75° C. less than the melting point of the polymer.

20. The process of claim 18, wherein the heating applied is at least 100° C. less than the melting point of the polymer.

21. The process of claim 18, wherein the adhesive is thermoset.

22. The process of claim 18, wherein the adhesive is a thermoset epoxy.

23. The process of claim 18, wherein the adhesive is applied to an outside surface of the preformed liner and the performed liner is inserted into the pipe.

24. The process of claim 18, wherein the adhesive is applied to the interior surface of the pipe and the preformed liner is inserted into the pipe.

25. The process of claim 21, wherein the adhesive is cured by heating.

26. The process of claim 22, wherein the epoxy is cured by heating.

27. The process of claim 18, wherein the heating step comprises inserting the pipe into an oven.

28. The process of claim 18, wherein a surface of the preformed liner is treated before the adhesive is applied to said surface

29. The process of claim 22, wherein the surface of the preformed liner has an etched surface to which the thermoset epoxy is applied.

30. The process of claim 18, wherein the pipe is an oil well pipe.

31. The process of claim 18, wherein the polymer of the preformed liner is a fluoropolymer.

32. The process of claim 31, wherein the fluoropolymer is melt-processible.

33. The process of claims 32, wherein the melt-processible fluoropolymer is selected from the group consisting of polychlorotrifluoroethylene, copolymers of tetrafluoroethylene (TFE) and chlorotrifluoroethylene (CTFE).

34. The process of claim 33, wherein the melt-processible fluoropolymer is a copolymer of TFE, wherein a comonomer is selected from the group consisting of a perfluoroolefin having 3 to 8 carbon atoms and a perfluoro(alkyl vinyl ether) (PAVE) in which the linear or branched alkyl group contains 1 to 5 carbon atoms.

35. The process of claim 31, wherein the polymer is a non-melt-processible fluoropolymer.

36. The process of claim 35, wherein the non-melt-processible fluoropolymer is polytetrafluoroethylene (PTFE) or modified PTFE.

37. The process of claim 18, wherein the preformed liner adhered to the interior surface of said pipe has a peel strength of at least 10 pounds force per inch (10 lbf/in).

38. The process of claim 18, wherein the peel strength of the preformed liner adhered to the interior surface of said pipe is at least 20 pounds force per inch (20 lbf/in).

39. The process of claim 18, wherein the preformed liner has a thickness of about 20 mils (500 micrometers) to about 250 mils ( 6350 micrometers).

40. The process of claim 18, wherein the preformed liner has a thickness of about 30 mils (750 micrometers) to about 200 mils ( 5100 micrometers).
